(19) United States
(12) Patent Application Publication
(10) Pub. No.: US 2011/0279248 A1
(43) Pub. Date: Nov. 17, 2011

(54) REMOTE INSTRUCTION TRANSMISSION/RECEPTION SYSTEM

(75) Inventor: Toshiyuki OGAWA, Fukuoka (JP)

(73) Assignee: PANASONIC CORPORATION, Osaka (JP)

(21) Appl. No.: 13/094,209

(22) Filed: Apr. 26, 2011

(30) Foreign Application Priority Data
May 13, 2010 (JP) 2010-110890

(51) Int. Cl. G08C 19/12

(52) U.S. Cl. 340/13.25

(57) ABSTRACT

A remote instruction transmission/reception system has a first transmission/reception apparatus, a plurality of second transmission/reception apparatuses, and an information processing apparatus. The second transmission/reception apparatuses each make a selection (choice) and emit an electromagnetic wave. The information processing apparatus transmits an instruction for electromagnetic wave emission states of the second transmission/reception apparatuses according to the selections, to the second transmission/reception apparatuses through the first transmission/reception apparatus. The second transmission/reception apparatuses transmits electromagnetic waves based on the light emission states according to the selections, and when the first transmission/reception apparatus receives the electromagnetic waves emitted from the second transmission/reception apparatuses, the information processing apparatus recognizes the selections made by the second transmission/reception apparatuses based on the light emission states of the electromagnetic waves and categorizes the second transmission/reception apparatuses into groups based upon the selections.

### CROSS-REFERENCE TO RELATED APPLICATIONS

The present application claims priority under 35 U.S.C. §119 of Japanese Application No. 2010-110890 filed on May 13, 2010, the disclosure of which is expressly incorporated by reference herein in its entirety.

### BACKGROUND OF THE INVENTION

1. Field of the Invention

The present invention relates to a remote instruction transmission/reception system including a plurality of transmission/reception apparatuses that transmit information via electromagnetic waves.

2. Description of Related Art

Information and Communication Technology (ICT) education, in which an electronic whiteboard, an electronic pen, and other devices are used, has become widespread as a new education style. An electronic pen is used to write on a touch panel of a display apparatus such as an electronic whiteboard. A system to enter information without directly touching an electronic pen to a touch panel has also been developed. In such a non-touch system, a camera is provided on the display apparatus and takes an image of the electronic pen to detect the position of the electronic pen (Refer to Related Art 1).

Further, a technology replacing a mouse for a personal computer has also been disclosed in which a pointer, such as an electronic pen having a light-emitting portion, is photographed by a camera, and the position of light emission is detected from the photographed image (Related Art 2).

In primary and secondary education in which the ICT education is employed, it is assumed that a plurality of students are seated looking at an electronic whiteboard and that a teacher asks a question based on information displayed on the electronic whiteboard. The teacher may not only ask one of the students to answer the question but also ask all the students to choose an answer from multiple choices (selection).

The technologies disclosed in Related Arts 1 and 2 have neither a function to simultaneously recognize a plurality of electronic pens, nor a function to identify information transmitted by the plurality of electronic pens. Thus, in the educational scene as described above, it is impossible to let each student to choose an answer with an electronic pen and recognize who has chosen which answer. However, categorizing the students into groups according to choices the students make with the electronic pens (such as remote selection) is deemed an important function. A remote instruction transmission/reception system is desired to enable such a function.

[Related Art 1] Japanese Patent Laid-open Publication No. 2009-48479

[Related Art 2] Japanese Patent Laid-open Publication No. H10-83246

### SUMMARY OF THE INVENTION

In view of the circumstances described above, an advantage of the present invention is to provide a remote instruction transmission/reception system that can categorize a plurality of transmission/reception apparatuses according to choices made with the transmission/reception apparatuses.

The present invention provides a remote instruction transmission/reception system including a first transmission/reception apparatus; a plurality of second transmission/reception apparatuses that each make a selection and emit an electromagnetic wave; and an information processing apparatus that transmits an instruction for electromagnetic wave emission states of the second transmission/reception apparatuses according to the selections, to the second transmission/reception apparatuses through the first transmission/reception apparatus. The second transmission/reception apparatuses transmits electromagnetic waves based on the light emission states according to the selections. When the first transmission/reception apparatus receives the electromagnetic waves emitted from the second transmission/reception apparatuses, the information processing apparatus recognizes the selections made by the second transmission/reception apparatuses based on the light emission states of the electromagnetic waves and categorizes the second transmission/reception apparatuses into groups based upon the selections.

The present invention provides the remote instruction transmission/reception system having a function of recognizing the choices made by the second transmission/reception apparatuses and categorizes the second transmission/reception apparatuses into groups based on the selections.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is an overall schematic view of a remote instruction transmission/reception system according to an embodiment of the present invention;

FIG. 2 is a block diagram of the remote instruction transmission/reception system according to the embodiment of the present invention;

FIG. 3 is a cross-sectional view illustrating an electronic pen according to the embodiment of the present invention;

FIG. 4 is a flowchart illustrating a process of calculating position information and recognizing attribution information of the electronic pen according to the embodiment of the present invention;

FIG. 5 is a flowchart illustrating a process of categorizing the electronic pen in the first light emission mode according to the embodiment of the present invention;

FIG. 6 illustrates recognition of an ID number of the electronic pen;

FIG. 7 illustrates an example of grouping of the electronic pen;

FIG. 8 is a flowchart illustrating a process in handwriting (mouse) mode of the electronic pen;

FIGS. 9(a) and 9(b) illustrate the handwriting (mouse) mode of the electronic pen;

FIG. 10 is a flowchart illustrating a process of categorizing the electronic pen in the second light emission mode according to the embodiment of the present invention; and

FIG. 11 illustrates an example of grouping in the second light emission mode.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The embodiment of the present invention is explained below with reference to the drawings.

Explanation of Entire Configuration

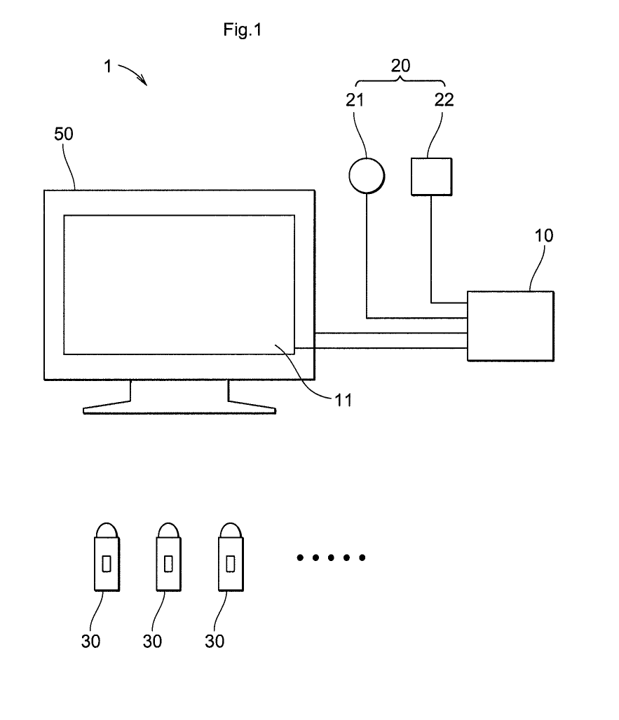

With reference to FIG. 1, a remote instruction transmission/reception system 1 according to the present embodiment has a first transmission/reception apparatus 20, a plurality of electronic pens (second transmission/reception apparatuses) 30, an information processing apparatus 10, and a display 50. The first transmission/reception apparatus 20 includes a camera 21 and a wireless transmitter 22. The electronic pens 30 each transmit and receive signals via lights (electromagnetic waves) in a position facing and faced by the first transmission/reception apparatus 20. The information processing apparatus 10 controls the first transmission/reception apparatus 20 and the electronic pens 30, and processes obtained data. The display 50 displays the information generated by the information processing apparatus 10. A touch panel 11 may be added to the display 50. An operator touches the touch panel 11 to enter a processing command and the like to the information processing apparatus 10.

The camera 21 is disposed so as to concurrently shoot or photograph the plurality of electronic pens 30. A configuration may be employed in which a plurality of cameras 21 are disposed so as to cover different spatial positions to concurrently shoot the plurality of electronic pens 30. It is preferable that sensitivity be selected for the camera 21 according to a wavelength band of light emitted from the electronic pens 30 and that shooting be performed with visible light and infrared light.

Specifications of the wireless transmitter 22 are not particularly limited and any type of wireless transmitter can be utilized so long as it can perform the necessary functions. The wireless transmitter 22 transmits signals to the electronic pens 30 via electromagnetic waves such as radio waves and light waves. The wireless transmitter 22 may be configured to perform 2.4 GHz band advanced low power data communication, for example.

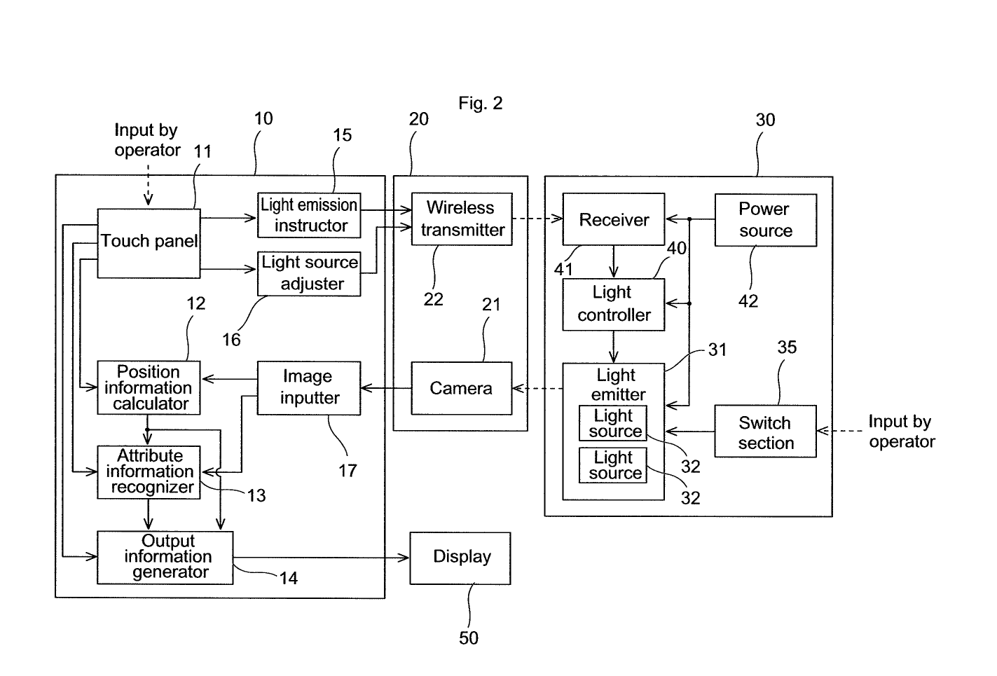

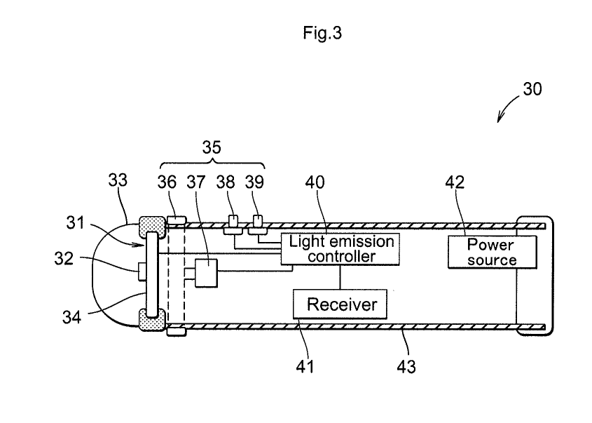

With additional reference to FIGS. 2 and 3, each of the electronic pens 30 has a tubular pen main body 43 configured to be held by a user, a light emitter 31 provided on one end of the pen main body 43, a switch section 35, a receiver 41, a light emission controller 40, and a power source 42. The switch section 35 is provided in the pen main body 43 to select turning ON or OFF of the light emitter 31. The receiver 41 receives an instruction from the information processing apparatus 10 through the first transmission/reception apparatus 20. The light emission controller 40 controls the light emission mode of the light emitter 31 based on the received instruction. The power source 42 supplies power to operate circuits of the receiver 41 and the light emission controller 40 and to emit light from the light emitter 31. In the present embodiment, the electronic pen is described as the second transmission/reception apparatus. In the educational scenes, however, terminal apparatuses carried by a plurality of students may be provided with the functions above. The second transmission/reception apparatus is thus not limited to the electronic pen, but includes any device that can perform the described functions.

The pen main body 43 is formed of a synthetic resin material, for instance. The shape is not limited to a pen-like shape as in the present embodiment, but may as non-limiting example be a glove shape or a wristband shape to be worn on a hand.

The light emitter 31 has a light source 32 having light-emitting elements disposed on a substrate 34 and a cover 33 protecting the light source 32. A plurality of LEDs (Light Emitting Diode) may be used as the light-emitting elements, the LEDs individually emitting infrared (IR), red (R), green (G), and blue (B) wavelengths. The infrared (IR) LED in the light source 32 emits light in a first wavelength band which is longer than a wavelength of visible red light. The red (R), green (G), and blue (B) LEDs in the light source 32 each emit light in a second wavelength band which is shorter than the wavelength of visible light red. Applying or employing the red (R), green (G), and blue (B) LEDs, which are three primary colors of light, in the light source 32 allows light emission in a variety of colors depending on combinations of LEDs. Power supply may be fluctuated according to an instruction from the light emission controller 40 to emit the light from the light source 32 at a plurality of luminance levels. For example, the light emitting luminance may be provided in three values of 0% (off: L), 50% (M), and 100% (H).

The cover 33, which is formed of a transparent synthetic resin material, for instance, has a lens function and a diffusion function. The cover 33 may be configured such that the LEDs emit light in a hemispherical shape and that light emission from the endmost apex portion has strong directivity. For instance, the cover 33 may have high directivity in the “handwriting mode” in which the screen of the display 50 is also used as a pointing device of a graphical user interface to computer graphics on display, in addition to display of characters, symbols, and drawings on the display 50. Thereby, reliability in input operation can be enhanced.

The switch section 35 has push-type tactile switches 38 and 39 to turn a specific function ON and OFF, a dial 36, and a rotary switch 37. The cylindrical dial 36 rotates around the external periphery of the electronic pen, and is connected with a movable axis of the rotary switch 37. The rotary switch 37 is configured to generate a plurality of selection information according to the rotation position of the movable axis.

Pressing an operation button of each of the push-type tactile switches 38 and 39 causes the light emission controller 40 to execute an assigned operation. For instance, the first tactile switch 38 may be assigned a function similar to a button of a mouse; and the second tactile switch 39 may be assigned a function to scroll the display screen forward and backward.

The rotary switch 37 selects attribute information which is mainly individual information. Rotating the dial 36 causes the rotary switch 37 to switch the attribute associated with the function of the electric pen 30. An operator of the electric pen 30 can use the switch section 35, which is a combination of the switches above, to make a selection from a variety of light emission states according to an occasion.

The receiver 41 has an antenna and a reception circuit (not shown in the drawing). The receiver 41 receives an instruction transmitted from the wireless transmitter 22 of the first transmission/reception apparatus 20 via an electromagnetic wave such as a radio wave and a light wave, and transmits the instruction to the light emission controller 40. The receiver 41 may be configured to perform 2.4 GHz band advanced low power data communication, for example, although other data communication modalities can also be utilized.

The light emission controller 40 recognizes the instruction from the information processing apparatus 10 based on a signal transmitted through the first transmission/reception apparatus 20 by an electromagnetic wave. The instruction includes light emission timing of the electronic pen 30, duration of light emission, selection of the light source 32 to be emitted, association of operation of the switch section 35 and a light emission state, time synchronization of light emission among the plurality of electronic pens 30, and the like. Based on the instruction transmitted from the information processing apparatus 10, the light emission controller 40 controls a light emission state associated with the attribute (individual) information in response to the operation of the switch section 35.

The light emission controller 40, which is one type of computer, has a processor (CPU) executing calculation, a random access memory (RAM) providing a memory area to temporarily store a variety of data and a work area for the processor to perform calculation, a read only memory (ROM) storing in advance programs that the processor executes and a variety of data used in calculation, and a rewritable non-volatile memory storing data to be saved from among calculation results of the processor and data provided from other sections. The ROM stores unique pen identification information (ID). A RAM having a backup function supplied with a constant voltage even after a system stops (i.e., is turned OFF) may serve as a non-volatile memory.

The power source 42 is a circuit that supplies power to operate the circuit of the electronic pen 30, and is provided with a battery. The battery is not limited to a particular type, and either a rechargeable type or a replacement type may be applied or utilized, for example. It is preferable that a rechargeable battery and a charging circuit of an electromagnetic induction type be provided for non-contact charging on an external charger, as is utilized for example in an electric toothbrush.

The information processing apparatus 10 has the touch panel 11 added to the display 50, a light emission instructor 15, a light source adjuster 16, an image inputter 17, a position information calculator 12, an attribute (individual) information recognizer 13, and an output information generator 14. The light emission instructor 15 instructs a light emission state of the electronic pen 30 based on an instruction entered on the touch panel 11. The image inputter 17 captures an image shot by the camera 21. The position information calculator 12 and the attribute information recognizer 13 process information after the image data processed at the image inputter 17 is imported. Based on the results processed at the position information calculator 12 and the attribute information recognizer 13, the output information generator 14 generates information to output to the display 50.

A personal computer (desktop, laptop, PDA, smartphone or other) may be used as the information processing apparatus 10, which has a processor (CPU) executing calculation, a random access memory (RAM) providing a memory area to temporarily store a variety of data and a work area for the processor to perform calculation, a read only memory (ROM) storing, in advance, programs that the processor executes and a variety of data used in calculation, and a rewritable non-volatile memory storing data to be saved among calculation results of the processor and data provided from other sections. A RAM having a backup function supplied with a constant voltage even after a system stops (i.e., is turned OFF) may serve as a non-volatile memory.

As described above, the information processing apparatus 10 controls operations of the electronic pen system, including processing image data using the image recognition functions of the image inputter 17, the position information calculator 12, the attribute information recognizer 13, and the like; supplying display information to the display 50; and processing input operations according to the information and/or commands entered on the touch panel 11. Compared with a wireless transmission/reception apparatus using an electromagnetic wave, the configuration above allows concurrent processing of a large amount of information.

The touch panel 11 has a planar touch screen on a front surface of a planar panel main body wired with electrodes. A touch operation is performed on the touch screen with a pointer, such as a user's finger and the like. The touch panel 11 is disposed on the front surface of the display 50 as a two-dimensional coordinate input unit.

The touch panel 11 employing an electrostatic capacitance type detects a position based on a change in electrostatic capacitance caused by a touch or approach of a finger. Such an electrostatic capacitance touch panel apparatus has first electrodes on one surface of a dielectric substrate and second electrodes on the other surface. When a user's finger touches or approaches the touch panel, the electrostatic capacitance changes in a portion where the first electrode and the second electrode intersect. A coordinate is calculated based on detection of the change in the electrostatic capacitance. Since the touch panel apparatus is disposed on a front surface of a display, the apparatus is transparent such that an image on the display can be identified.

In combination, the large screen display 50, the touch panel 11 is used as what is commonly called an interactive whiteboard, which is used in a presentation or lecture. In the present embodiment, the display 50 is a plasma display (PDP) or a liquid crystal display and is disposed on the rear surface side of the main body. Transmission electrodes and reception electrode, all of which are composed of a transparent material, are provided on a front side of the touch panel 11. Of course, other types of display can also be utilized.

The instruction controlling unit is not limited to the touch panel 11, but may be a keyboard or a mouse for input to a PC.

The light emission instructor 15 synchronizes a light emission time among the plurality of electronic pens 30, and transmits to the light emission controller 40 of each of the electronic pens 30, an instruction of first light emission mode defining a timing and a duration of light emission associated with attribute (individual) information selected by operation of the switch section 35.

The timing and duration of light emission are explained below. A predetermined time (100 ms, for example) is assigned to a time to recognize (recognition time) the attribute (individual) information of light emission of the electronic pen 30 in the first light emission mode. The recognition time is further divided into time slots of 1 ms, for example. Numbers are assigned to the time slots for identification or analysis. The light emission controller 40 of each electronic pen 30 stores information to emit light at a predetermined time slot number corresponding to the attribute (individual) information and to continue the light emission for a predetermined time slot.

For example, the electronic pen 30 having an attribute of A stores in the light emission controller 40, instruction information to emit light at the fifth time slot (after elapse of 5 ms from time 0) and to turn off the light at the tenth time slot (before elapse of 11 ms from time 0). In a case where an operator X of the electronic pen 30 selects an attribute of group A with the switch section 35, the electronic pen 30 of the operator X begins to emit light at the fifth time slot and turns off the light at the tenth times slot.

In the case where the plurality of electronic pens 30 are utilized, light emission is controlled based on the synchronized time. Thus, the electronic pens 30 of operators who select A concurrently emit light at the fifth time slot and turn off the light at the tenth time slot. The electronic pens 30 of operators who select a different attribute emit light at a different timing for a different duration. It is also possible to set the predetermined time (100 ms, for example) as a recognition time for repeated light emissions, thereby the amount of information obtained is increased to enhance the reliability of the information. The timing and duration of light emission are controlled based on the synchronized time as described above. Thus, further dividing the time or changing the timing to emit and turn off the light allows easy grouping per attribute even when there are numerous second transmission/reception apparatuses.

The light source adjuster 16 transmits to the light emission controller 40 of the electronic pen 30, an instruction of second light emission mode defining a color and luminance of the light source 32 corresponding to the attribute (individual) information selected by operation on the switch section 35. For example, a plurality of LEDs are applied as light emitting elements of the light source 32, the LEDs individually outputting wavelengths of infrared (IR), red (R), green (G), and blue (B); and power supply is controlled such that the light emitting luminance has three values of 0% (off: L), 50% (M), and 100% (H). Thereby, even in a case of many attributes, a variety of light emission patterns can be selected and groupings can be performed easily.

The image inputter 17 captures an image from the camera 21 and converts the image into image data for processing at the CPU.

Based on the image data transmitted from the image inputter 17, the position information calculator 12 calculates the position of the light-emitting electronic pen 30. In the present embodiment, the position of the electronic pen 30 is calculated based on the light from the infrared (IR) LED of the light source 32, the infrared LED being in the first wavelength band having a wavelength longer than red visible light.

Infrared light is used for position calculation of the electronic pen 30 because the infrared light can be received without being blended into visible light traveling toward the first transmission/reception apparatus 20 from around the electronic pen 30, thus preventing misidentification of the position information.

The attribute information recognizer 13 recognizes the attribute (individual) information of the light-emitting electronic pen 30 based on the image data transmitted from the image inputter 17. As described above, the electronic pen 30 has other attribute (individual) information selected by operation of the switch section 35, based on the unique pen identification information (ID) stored in the light emission controller 40 and the information transmitted from the information processing apparatus 10. The information is transmitted to the information processing apparatus 10 by light emission of the light source 32 in the first light emission mode and the second light emission mode. The attribute information recognizer 13 converts the image data into the attribute (individual) information according to the light emission state in the first light emission mode and the second light emission mode.

The output information generator 14 generates information to be output to the display 50 based on processing results of the position information calculator 12 and the attribute information recognizer 13. In a case where a teacher asks students to select an answer from some options (selection) at school, for example, the output information may be a table showing the number of students per option or an answer of a specific student.

The position information calculator 12 calculates a position of one electronic pen 30 in advance, and then the attribute information recognizer 13 recognizes the attribute (individual) information of the electronic pen 30 whose position is indentified. Thereby, the information is prevented from being blended into surrounding light and being confused with that of a plurality of electronic pens 30, and thus accurate output information can be generated.

The display 50 displays the information generated by the output information generator 14. The display 50 may be a large plasma display (PDP) or a liquid crystal display. The display 50 also functions as a display of a regular PC, and displays characters, figures, symbols, and photographs based on instruction from the PC. For instance, a teacher can display a question to students, an answer, a presentation, and the like at school.

Subsequently, an example of the present embodiment is explained with reference to the drawings. In the process explained below, an operator (teacher, for example) operates the touch panel 11 of the information processing apparatus 10 to enter an instruction, and then the information processing apparatus 10 executes the instruction at a predetermined processing interval (for example, 1 ms to 100 ms). The process is executed by the CPU installed in the information processing apparatus 10.

Information Processing Process According to Wavelength Band of Light

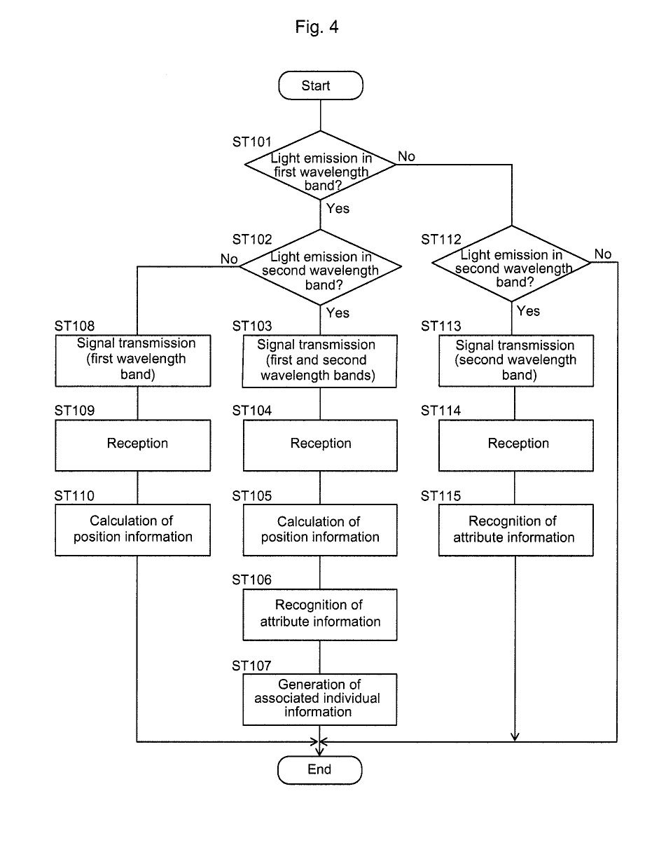

FIG. 4 illustrates a basic process of transmitting and receiving remote instruction according to a wavelength band of light performed by the information processing apparatus 10. The electronic pen 30 emits light, in response to selection of the switch section 35 by an operator (student, for example). The light in the first wavelength band having a longer wavelength than red visible light is emitted by the infrared (IR) LED in the light source 32; and the light in the second wavelength band having a shorter wavelength than red visible light is emitted by the red (R), green (G), or blue (B) LED in the light source 32. In the example, a case is explained in which both or either of the light is emitted.

Examples of the case of emitting only the light in the first wavelength band include a case in which only the position information of the individual electronic pens 30 is calculated to confirm the total number of the electronic pens 30 and a case in which a moving coordinate of the electronic pen 30 is recognized. An example of the case of emitting only the light in the second wavelength band is a case in which the position information of the electronic pen 30 stored in advance is used to recognize the attribute (individual) information. An example of the case of emitting both the light in the first and second wavelength bands is a case in which the position information and the attribute (individual) information of the electronic pen 30 are concurrently recognized.

An operator (teacher, for example) operates the touch panel 11 to instruct an operation mode, such as to confirm the number of attending students (confirm the number of light-emitting electronic pens 30) or take attendance using IDs of electronic pens 30, or have students enter characters, symbols, figures, and the like (remote handwriting) or have students select an answer from some options (selection). According to the instructed operation mode, the light emission instructor 15 or the light source adjuster 16 then determines whether the light in the first wavelength band is emitted from the target electronic pens 30 (ST101). When the light emission instruction is for the light in the first wavelength band, it is further determined whether the instruction is that the light in the second wavelength band is also emitted (ST102).

When the instruction is that both the light in the first and second wavelength bands is emitted (ST102: YES), the light emission instructor 15 or the light source adjuster 16 transmits a signal representing the instruction to the electronic pens 30 through the wireless transmitter 22 of the first transmission/reception apparatus 20 (ST103). Thereafter, an operator (student, for example) holding the electronic pen 30 makes a selection on the switch section 35 to emit light from the light emitter 31. The electronic pen 30 then emits both the light in the first and second wavelength bands, following (i.e., based on) the signal transmitted from the light emission instructor 15 or the light source adjuster 16.

The image inputter 17 receives an image of the light-emitting electronic pen 30 captured by the camera 21 of the first transmission/reception apparatus 20 (ST104). The image inputter 17 transmits the image data to be processed at the CPU to the position information calculator 12, which then performs image analysis of the light in the first wavelength band to calculate the position information (ST105). The light in the first wavelength band is infrared light, which can be easily distinguished from noise or light surrounding the electronic pen 30. Thus, the position of the electronic pen 30 can be surely calculated.

After the position information calculator 12 calculates the position of the electronic pen 30, the attribute information recognizer 13 performs image analysis of the light in the second wavelength band at the calculated position to recognize the attribute (individual) information of the electronic pen 30 (ST106). In the recognition of the attribute (individual) information of the electronic pen 30 whose position is identified in advance, noise or light surrounding the electronic pen 30 can be easily distinguished, and the attribute (individual) information of the electronic pen 30 can be recognized with certainty.

The attribute (individual) information that the attribute information recognizer 13 recognizes includes unique pen identification information (ID) stored in the light emission controller 40. The position information and the ID are associated with each other. Based on the position information, the ID, and other attribute (individual) information, the output information generator 14 associates the position information and the attribute (individual) information according to the instruction entered by the operator (teacher, for example) on the touch panel 11, and then generates accumulated results of the individual information or selection results of the electronic pens 30 (ST107).

When the instruction is that only the light in the first wavelength band is emitted (ST102: NO), processes similar to ST104 and ST105 are performed (ST109 and ST110). The position information calculated in ST110 may be stored in the memory of the information processing apparatus 10 or may be used to generate output information by the output information generator 14.

When the instruction is that the light in the first wavelength band is not emitted (ST101: NO), it is determined whether the instruction is that the light in the second wavelength band is emitted (ST112). When the instruction is that the light in the second wavelength band is emitted (ST112: YES), the light emission instructor 15 or the light source adjuster 16 transmits a signal representing the instruction to the electronic pen 30 through the wireless transmitter 22 of the first transmission/reception apparatus 20 (ST113). Thereafter, processes similar to ST104 and ST106 are performed (ST114 and ST115). When the attribute information recognizer 13 performs image analysis of the light in the second wavelength band to recognize the attribute (individual) information in ST115, the attribute information recognizer 13 can obtain the light in the second wavelength band at the position by using the previously stored position information of the electronic pen 30. The recognition of the attribute (individual) information in ST115 may be eliminated depending on the operation mode (in a case of emitting the light of the electronic pen 30 merely for instruction to students, for example).

The attribute (individual) information calculated in ST115 may be stored in the memory of the information processing apparatus 10 or may be generated as output information by the output information generator 14. When the instruction is that neither the light in the first and second wavelength band is emitted (ST112: NO), the process ends.

In the present embodiment as described above, infrared light is used as the light in the first wavelength band to calculate the position information while eliminating noise due to visible light around the electronic pen 30 and to recognize the attribute (individual) information of the electronic pen 30 at the calculated position information. Thereby, highly reliable individual information of the electronic pen 30 can be obtained. In addition, the position information or the attribute (individual) information only can be stored in the memory in advance to use the information in the subsequent information processing.

Information Processing Process According to First Light Emission Mode

Subsequently, an information processing process is explained in a case where an operator (teacher, for example) performs an instruction for the first light emission mode on the touch panel 11. The first light emission mode herein refers to a way to categorize a plurality of electronic pens 30 into a plurality of groups according to the attribution (individual) information of the pens, at least relating to control of a light emission timing and a light emission duration. The process explained below includes a process executed by the information processor 10 and a control process executed by the light emission controller 40 of the electronic pen 30.

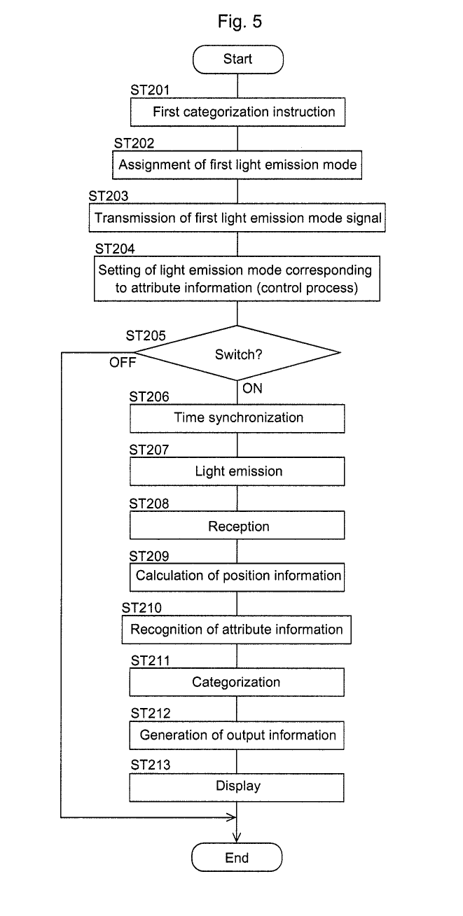

With reference to FIG. 5, an operator (teacher, for example) operates the touch panel 11 to provide the instruction for the first light emission (ST201). The light emission instructor 15 then synchronizes the light emission time of the plurality of electronic pens 30 to one another, and assigns a timing and a duration of light emission corresponding to the attribute (individual) information selected by operation on the switch section 35 (ST202).

A command signal of the first light emission mode is transmitted to the light emission controller 40 of the electronic pen 30 through the wireless transmitter 22 of the first transmission/reception apparatus 20 (ST203).

The light emission controller 40 of each electronic pen 30 stores information to emit light at a predetermined time slot number corresponding to the attribute (individual) information and to continue the light emission for a predetermined time slot. When receiving the signal from the information processing apparatus 10, the light emission controller 40 sets a control process so as to emit the light from the light emitter 31 in a light emission state corresponding to the attribute (individual) information when the state is selected by the switch section 35, based on the first light emission mode (ST204).

When the light emission state corresponding to the attribute (individual) information is selected by the switch section 35 (ST205), the light emission controller 40 synchronizes the time with the control signal received from the wireless transmitter 22 of the first transmission/reception apparatus 20 (ST206).

Subsequently, the light emission controller 40 emits the light in the first and second wavelength bands from the light emitter 31 at the time slot specified in the first light emission mode (light emission timing and duration) based on the selected light emission state corresponding to the attribute (individual) information of the electronic pen 30 (ST207).

The image inputter 17 receives an image of the light-emitting electronic pen 30 shot by the camera 21 of the first transmission/reception apparatus 20 (ST208). The image inputter 17 transmits the image data to be processed at the CPU to the position information calculator 12, which then performs image analysis of the light in the first wavelength band to calculate the position information (ST209).

When the position information calculator 12 calculates the position of the electronic pen 30, the attribute information recognizer 13 performs image analysis of the light in the second wavelength band of the electronic pen 30 to recognize the attribute (individual) information (ST210).

The attribute (individual) information that the attribute information recognizer 13 recognizes includes the unique pen identification information (ID) stored in the light emission controller 40. The position information and the ID are associated with each other. Based on the position information, the ID, and other attribute (individual) information, the output information generator 14 categorizes the plurality of electronic pens 30 into a plurality of groups according to the instruction for the first light emission mode entered by the operator (teacher, for example) on the touch panel 11 (ST211).

The output information generator 14 associates the position information and the attribute (individual) information, and generates accumulated results of the individual information and selection results of the electronic pens 30 (ST212). The results are output from the output information generator 14 to the display 50 as signals, and displayed on the display 50 (ST213).

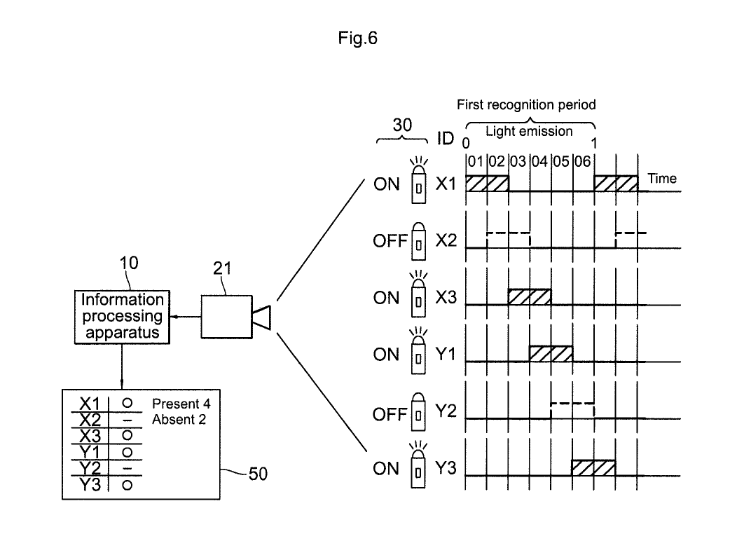

FIG. 6 is an example of the first light emission mode in which a teacher takes attendance of students. Attendance is checked by lighting of each identification number (ID) of the electronic pen 30. Both the light in the first wavelength band (infrared) and the light in the second wavelength band (red (R), green (G), and blue (B)) may be concurrently emitted. Alternatively, only the light in the second wavelength band may be emitted when the position information obtained immediately before is used.

With reference to FIG. 6, six electronic pens 30 each having an identification number (ID) are turned on or off. In a time slot chart on the right side in FIG. 6, the electronic pen 30 having an ID of X1 has attribute (individual) information of “Present” as turning the light on for two time slots of 01 and 02 from time 0; and the electronic pen 30 having an ID of X2 has attribute (individual) information of “Absent” as not turning the light on for two time slots of 02 and 03. The instruction for the first light emission mode is thus a command to control the timing and duration of light emission according to the attribute (individual) information of each electronic pen 30.

In FIG. 6, four electronic pens having IDs of X1, X3, Y1, and Y3 are selected by the switch sections 35 to emit light (ON), and those of X2 and Y2 are OFF by the switch sections 35. As shown by the shaded portions in the time slot chart, the ON electronic pens 30 emit light at time slots corresponding to the IDs. Meanwhile, the OFF electronic pens 30 do not emit light in time slots corresponding to the IDs indicated by a broken line.

The time slots are set by dividing a recognition period of a predetermined time, as described above. Setting a predetermined time (100 ms, for example) as the recognition period to repeated light emission increases an amount of obtained information, thus enhancing reliability of the information. FIG. 6 shows only the first recognition period and a portion of the second recognition period.

The camera 21 shoots an image of the light-emitting electronic pens 30, and transmits the shot image to the information processing apparatus 10. Based on the position information of the electronic pens 30 obtained through image analysis of the image data or the stored position information and the light emission state, the information processing apparatus 10 categorizes the plurality of electronic pens 30 into a plurality of groups according to the instruction for the first light emission mode entered by the operator (teacher, for example) on the touch panel 11. The display 50 displays the categorization results of students' attendance.

In the embodiment shown in FIG. 6, a table of the IDs of the electronic pens 30 and attendance is displayed. Also, the numbers of the present students and absent students are also displayed. Attendance can easily be confirmed in the present embodiment as described above.

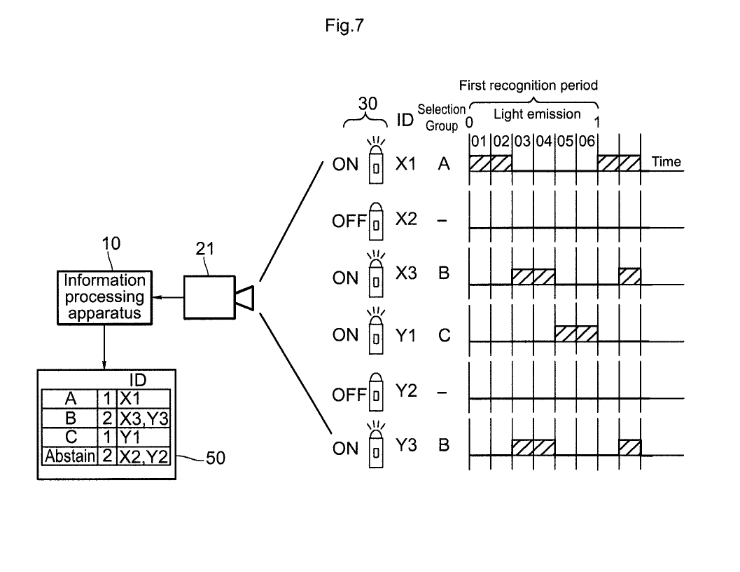

FIG. 7 is another example of the first light emission mode. In FIG. 7, IDs of a plurality of electronic pens 30 explained in FIG. 6 are confirmed in advance. A situation is assumed in FIG. 7 in which a teacher asks students to select an answer from some options (A, B, and C) (selection). Both the light in the first wavelength band (infrared) and the light in the second wavelength band (red (R), green (G), and blue (B)) may be concurrently emitted. Alternatively, only the light in the second wavelength band may be emitted when the position information obtained immediately before is used.

A student selects A, B, or C, and selects a light emission state using the switch section 35 of the electronic pen 30. Subsequently, the switch section 35 selects light emission, and then the electronic pen 30 emits light at a time slot corresponding to the attribute (individual) information. In a time slot chart on the right side in FIG. 7, the electronic pen 30 having an ID of X1 selects “A” and transmits attribute (individual) information of “A” by turning the light on for two time slots of 01 and 02 from time 0; the electronic pen 30 having an ID of X3 selects “B” and transmits attribute (individual) information of “B” by turning the light on for two time slots of 03 and 04; and the electronic pen 30 having an ID of Y1 selects “C” and transmits attribute (individual) information of “C” by turning the light on for two time slots of 05 and 06.

In FIG. 7, four electronic pens 30 having IDs of X1, X3, Y1, and Y3 are selected by the switch sections 35 to emit light (ON), and those of X2 and Y2 are OFF by the switch sections 35. As shown by the shaded portions in the time slot chart, the ON electronic pens 30 emit light at time slots corresponding to groups A, B, and C. Meanwhile, the OFF electronic pens 30 do not emit light. The OFF electronic pens 30 are assumed to be “abstaining”(or “absent”).

The camera 21 shoots an image of the light-emitting electronic pens 30, and transmits the shot image to the information processing apparatus 10. Based on the position information of the electronic pens 30 obtained through image analysis of the image data or the stored position information and the light emission state, the information processing apparatus 10 categorizes the plurality of electronic pens 30 into a plurality of groups according to the instruction for the first light emission mode entered by the operator (teacher, for example) on the touch panel 11. The display 50 displays the categorization results.

In the embodiment shown in FIG. 7, a table indicates the number of students in the groups A, B, C, and “abstaining” along with the IDs. Selection by a plurality of respondents from multiple options can easily be performed in the present embodiment as described above.

Processing Process of Recognizing Moving Coordinate

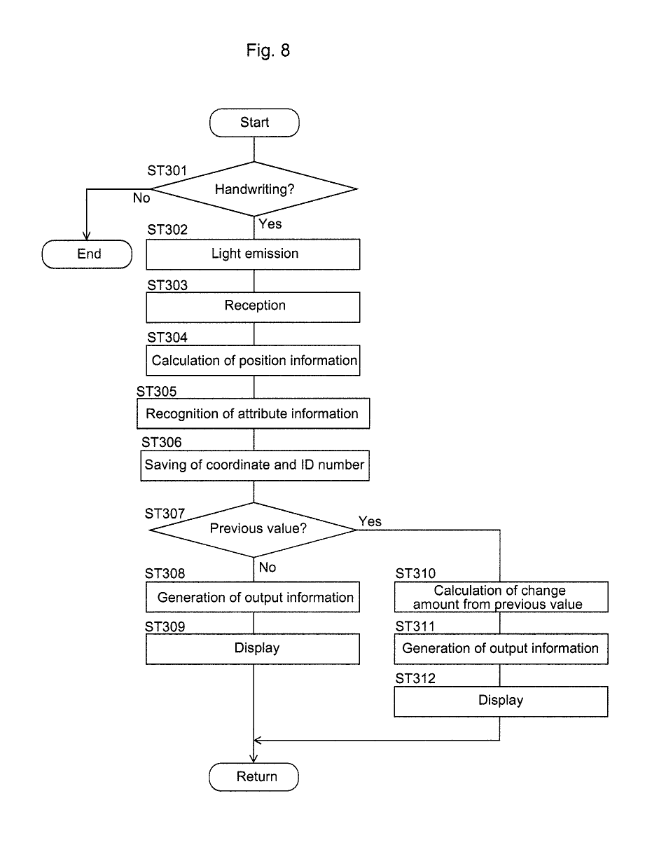

Subsequently, a processing process for recognizing a moving coordinate is explained with reference to FIG. 8. The processing process for recognizing a moving coordinate in the present embodiment enables a function of a handwriting mode (mouse mode) by the electronic pen 30. The function allows display of characters, symbols, figures, and the like on the display 50 through the information processing apparatus 10. The function can also be used as a pointing device for a graphical user interface for computer graphics displayed on the screen of the display 50. It is assumed that the “handwriting mode” is used as an example in a situation in which a teacher asks one student to draw a character, a symbol, or a figure.

The light emission controller 40 of the electronic pen 30 determines whether the electronic pen 30 is set to “handwriting mode” by an operator actuating the switch section 35 (ST301). When the “handwriting mode” is selected, the light emission controller 40 emits light from the light source 32 of the light emitter 31 according to the selected attribute (individual) information (ST302). As described above, the wavelength band, timing, and duration are appropriately selected for the light emission state according to the attribute (individual) information. The light emission state corresponding to the attribute (individual) information may be stored in advance in the memory of the light emission controller 40, or temporarily stored in the memory of the light emission controller 40 according to a command from the light emission instructor 15 or the light source adjuster 16 of the information processing apparatus 10.

When the electronic pen 30 emits light, the camera 21 of the first transmission/reception apparatus 20 shoots (receives) an image of the electronic pen 30 (ST303), and transmits the shot image to the image inputter 17 of the information processing apparatus 10. The image inputter 17 transmits the image data to be processed at the CPU to the position information calculator 12 and the attribute information recognizer 13.

The position information calculator 12 calculates the position of the electronic pen 30 as a coordinate (ST304). The attribute information recognizer 13 recognizes that the electronic pen 30 is in the “handwriting mode” and the identification number of the electronic pen 30 (ST305). The calculated position information and the attribute (individual) information are stored in the memory of the attribute information recognizer 13 (ST306).

The attribute information recognizer 13 determines whether or not there is a previous value associated with the obtained identification number and the coordinate data of the electronic pen 30 (ST307).

When there is no previous value (ST307: NO), the position information calculator 12 and the attribute information recognizer 13 transmit to the output information generator 14 the identification number and the coordinate data. The output information generator 14 generates information to display the coordinate of the electronic pen 30 as a pointer on the display 50 (ST308). The pointer of the electronic pen 30 is displayed overlapping an image originally displayed on the display, for example (ST309).

When there is a previous value (ST307: YES), the attribute information recognizer 13 calculates a change amount from the previous value to the latest value based on the coordinate data (ST310). The change (movement) of the electronic pen 30 may be achieved, for instance, by the operator moving the electronic pen 30 in vertical and horizontal directions (and combination thereof) to change the location of the pointer on the display while looking at the pointer of the electronic pen 30 displayed on the display 50.

The calculated change amount is transmitted to the output information generator 14, which generates information to display the latest coordinate of the electronic pen 30 as a pointer on the display 50 (ST311). In the step, the output information generator 14 may display a trajectory from the previous value to the latest value. In the configuration above, the handwriting mode (mouse mode) of the electronic pen 30 can be achieved to enter characters, symbols, and figures. The pointer of the electronic pen 30 is displayed overlapping an image originally displayed on the display 50, for example (ST312). Since only the position information of the electronic pen 30 is required in the process, only the light in the first wavelength band (infrared) may be emitted. It may also be configured to obtain the attribute (individual) information of the electronic pen 30 from the second wavelength band at a predetermined interval.

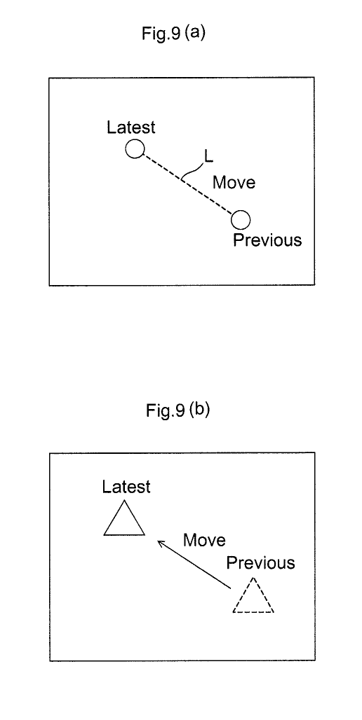

With reference to FIG. 9(a), a trajectory L is displayed by a broken line to show the move of the pointer of the electronic pen 30 from the previous value to the latest value. With reference to FIG. 9(b), only the latest value after the movement is displayed without the previous value (represented by an arrow), which is displayed in the mouse mode. The process of recognizing the moving coordinate in the present embodiment can thus achieve the handwriting mode (mouse mode) of the electronic pen 30.

Information Processing Process According to Second Light Emission Mode

Subsequently, an information processing process is explained in a case where an operator (teacher, for example) performs an instruction for the second light emission mode on the touch panel 11. The second light emission mode herein refers to a way to categorize a plurality of electronic pens 30 into a plurality of groups according to the attribution (individual) information of the pens, at least relating to control of color and luminance of light emission of the electronic pens 30. The process explained below also includes a control process executed by the light emission controller 40 of the electronic pen 30.

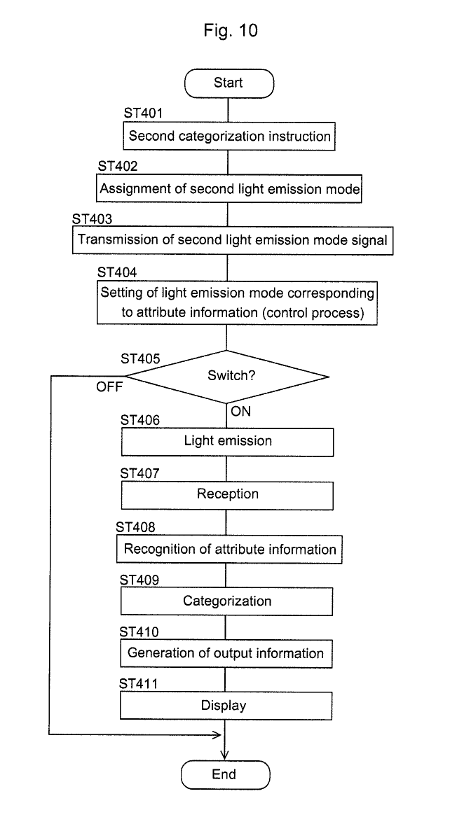

With reference to FIG. 10, an operator (teacher, for example) operates the touch panel 11 to provide the instruction for the second light emission mode (ST401). The light source adjuster 16 then assigns a color and a luminance for each group corresponding to the attribute (individual) information selected by operation of the switch section 35 (ST402). In the second light emission mode, for example, a light source is provided in three primary colors of red (R), green (G), and blue (B).

A command signal of the second light emission mode is transmitted to the light emission controller 40 of the electronic pen 30 through the wireless transmitter 22 of the first transmission/reception apparatus 20 (ST403).

The light emission controller 40 of each electronic pen 30 stores information to emit light from the light emitter 31 in a predetermined color and luminance corresponding to the attribute (individual) information. When receiving the signal from the information processing apparatus 10, the light emission controller 40 sets a control process so as to emit the light from the light emitter 31 in a light emission state corresponding to the attribute (individual) information when the state is selected by the switch section 35 (ST404), based on the second light emission mode.

The light emission state corresponding to the attribute (individual) information is selected by the switch section 35 (ST405).

Subsequently, the light emission controller 40 emits the light from the light emitter 31 in the color and luminance specified in the second light emission mode, based on the selected light emission state corresponding to the attribute (individual) information of the electronic pen 30 (ST406).

The image inputter 17 receives an image of the light-emitting electronic pen 30 shot by the camera 21 of the first transmission/reception apparatus 20 (ST407).

The attribute information recognizer 13 performs image analysis to recognize the attribute (individual) information (ST408).

Based on the attribute (individual) information, the output information generator 14 categorizes the plurality of electronic pens 30 into a plurality of groups according to the instruction for the second light emission mode entered by the operator (teacher, for example) on the touch panel 11 (ST409).

The output information generator 14 generates categorization information to be output (ST410). The results are output from the output information generator 14 to the display 50 as signals, and displayed on the display 50 (ST411).

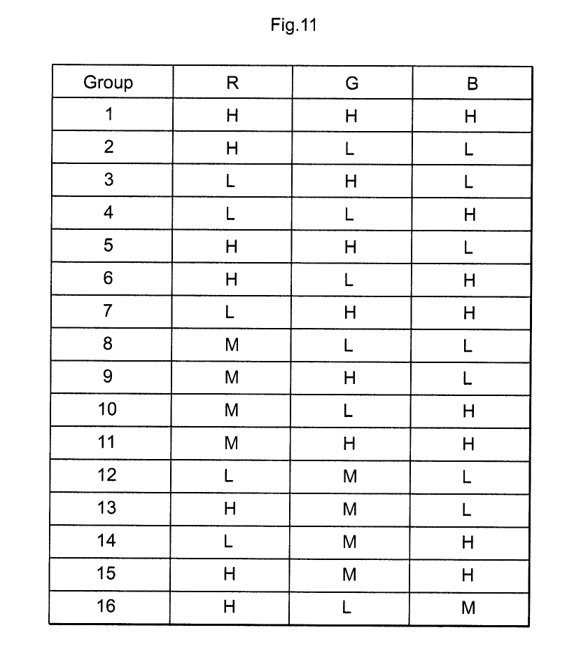

FIG. 11 illustrates an embodiment in which the light emitting luminance has three values of 0% (off: L), 50% (M), and 100% (H) based on fluctuation of power supply according to a command from the light emission controller 40 in a combination of the light source 32 having three primary colors of red (R), green (G), and blue (B).

In the present embodiment, 16 categorized groups are each assigned a color and luminance. For example, Group 1 is assigned with red at 100% (R at H), green at 100% (G at H), and blue at 100% (B at H); and Group 10 is assigned with red at 50% (R at M), green at 0% (G at L), and blue at 100% (B at H).

In the information processing process according to the second light emission mode as described above, controlling the color and luminance of the light emitted from the electronic pens 30 allows light emission in different color and luminance for every group, thus preventing misidentification of the attribute (individual) information. In addition, combining a plurality of colors and a plurality of luminance levels allows easy grouping even in the case where there are many electronic pens 30. Furthermore, using the light source having three primary colors of red (R), green (G), and blue (B) as in the present embodiment allows light emission in a variety of colors depending on combinations, and is easily adoptable even in the case where there are many categorized groups.

The second light emission mode related to the color and luminance in combination with the first light emission mode related to the timing and duration of light emission may be applied even in the case where there is a substantial number of categorized groups. Further, the position information, identification numbers, and other attribute (individual) information may be combined to be applied in combination with complex options.

The preferred embodiments of the present invention were explained above. The present invention is not limited to those illustrated in the drawings. The design may be changed within the scope of the concept. In a case where a teacher designates one student, for instance, the information processing apparatus 10 may be configured to cause the electronic pen 30 to emit light, independent from the switch section 35 in control of light emission of the electronic pen 30. Further, in a case where students play different instruments together in a music class, the information processing apparatus 10 may be configured to cause the electronic pen 30 to emit light to give a cue to sound. Furthermore, a sound output circuit may be added to the electronic pen 30 so as to generate a sound at the same timing as light emission.

The present invention is effective as a remote instruction transmission/reception system having a function to simultaneously recognize positions of a plurality of electronic pens and a function to identify information transmitted from the electronic pens, associating the position information and the attribute (individual) information, and enabling remote selection and handwriting with the electronic pens. The present invention is effective in particular in ICT education in which an electronic whiteboard, an electronic pen, and other devices are used.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A remote instruction transmission/reception system comprising:
a first transmission/reception apparatus;
a plurality of second transmission/reception apparatuses that each make a selection and emit an electromagnetic wave; and
an information processing apparatus that transmits an instruction for electromagnetic wave emission states of the second transmission/reception apparatuses according to the selections, to the second transmission/reception apparatuses through the first transmission/reception apparatus, wherein
the second transmission/reception apparatuses transmits electromagnetic waves based on the light emission states according to the selections, and
when the first transmission/reception apparatus receives the electromagnetic waves emitted from the second transmission/reception apparatuses, the information processing apparatus recognizes the selections made by the second transmission/reception apparatuses based on the light emission states of the electromagnetic waves and categorizes the second transmission/reception apparatuses into groups based upon the selections.

2. The remote instruction transmission/reception system according to claim 1, wherein the electromagnetic wave emission states comprise an emission timing.

3. The remote instruction transmission/reception system according to claim 1, wherein the electromagnetic wave emission states comprise an emission duration.

4. The remote instruction transmission/reception system according to claim 1, wherein the electromagnetic wave emission states comprise a wavelength.

5. The remote instruction transmission/reception system according to claim 1, wherein the electromagnetic wave emission states comprise a luminance.

6. The remote instruction transmission/reception system according to claim 1, wherein the electromagnetic waves include first waves that the information processing apparatus uses to determine positions of the second transmission/reception apparatuses.

7. The remote instruction transmission/reception system according to claim 6, wherein the first waves are radio waves.

8. The remote instruction transmission/reception system according to claim 7, wherein the first waves are infrared rays.

9. The remote instruction transmission/reception system according to claim 1, wherein the electromagnetic waves include second waves including identification information of the second transmission/reception apparatuses.

10. The remote instruction transmission/reception system according to claim 9, wherein the first waves are lights.

11. The remote instruction transmission/reception system according to claim 1, wherein the first transmission/reception apparatus has an imaging unit that shoots the second transmission/reception apparatuses and transmits an image of the second transmission/reception apparatuses to the information processing apparatus.

12. The remote instruction transmission/reception system according to claim 1, wherein the second transmission/reception apparatuses are electronic pens.

13. The remote instruction transmission/reception system according to claim 1, wherein the second transmission/reception apparatuses have switches with which operators make the selections.

14. The remote instruction transmission/reception system according to claim 1, further comprising an instruction controller with which an operator inputs the instruction.

15. The remote instruction transmission/reception system according to claim 1, wherein the instruction controller is a touch screen device.

16. The remote instruction transmission/reception system according to claim 1, further comprising a display that displays the groups based upon the selections.

17. The remote instruction transmission/reception system according to claim 1, wherein each of the plurality of second transmission/reception apparatuses are configured to emit unique electromagnetic waves.

18. The remote instruction transmission/reception system according to claim 1, wherein the electromagnetic wave emitted by each of the plurality of second transmission/reception apparatuses identifies one of the plurality of second transmission/reception apparatuses and a location of the one of the plurality of second transmission/reception apparatuses.

19. The remote instruction transmission/reception system according to claim 1, wherein the first transmission/reception apparatus comprises at least one camera having a field of view that includes all of the plurality of second transmission/reception apparatuses.

20. The emote instruction transmission/reception system according to claim 1, wherein the information processing apparatus determines whether one of the plurality of second transmission/reception apparatuses has emitted light in a first wavelength band and whether one of the plurality of second transmission/reception apparatuses has emitted light in a second wavelength band, and, in response to an indication that light in the first wavelength band has been emitted, the information processing apparatus calculates a position of the second transmission/reception apparatus, in response to an indication that light in the second wavelength band has been emitted, the information processing apparatus determines attribute information of the second transmission/reception apparatus, and in response to an indication that light in the first wavelength band and in the second wavelength band has been emitted, the information processing apparatus determines a position and attribute information of the second transmission/reception apparatus.
